(19) United States
(12) Patent Application Publication
(10) Pub. No.: US 2012/0039491 A1
(43) Pub. Date: Feb. 16, 2012

(54) INERTIAL TYPE ACOUSTIC TRANSDUCER

(76) Inventor: Robert Katz, Montreal (CA)

(21) Appl. No.: 13/262,591

(22) PCT Filed: Mar. 31, 2010
(86) PCT No.: PCT/IB2010/000956

§ 371 Date: Sep. 30, 2011

Related U.S. Application Data
(60) Provisional application No. 61/165,901, filed on Apr. 1, 2009.

(51) Int. Cl. H04R 23/00

(52) U.S. Cl. 381/120; 381/150

(57) ABSTRACT

The present invention is drawn to inertial type transducers and a system for reducing the complexity and difficulty of installing the transducers internal to a structure. The transducer is equipped with a wireless receiver for receiving both sound content signals and control signals, and an amplifier, along with a power supply. Because the amplifier is activated by the wireless receiver, there are no wires necessary to connect the transducer to the source of the sound content or control signals thereby vastly simplifying installation. Heat dissipation and height minimization are also addressed.

### FIELD OF THE INVENTION

The present invention relates generally to electrodynamic, inertial type acoustic transducers or other inertial type sound generating transducers and, more particularly, to momentum or inertial type voice coil actuators capable of converting energy between electrical and mechanical form and novel ways to permit them to be used.

### BACKGROUND OF THE INVENTION

The development of the inertial type acoustic actuator field has been growing and advancing. These devices offer benefit over sound distributed by loud speakers because of their ability to radiate sound through substrates. The sound produced is more accurate and, in line with consumer demand, the intertial type acoustic actuator can be mounted in such a way as to employ a wall, ceiling, or even furniture as the substrate therefore becoming nearly if not completely “invisible” sound systems, or sound systems that can be hidden from view. A disadvantage of the acoustic type actuator is that mounting and installing them to remain hidden can be complex and difficult. Wiring the transducers from the electrical subsystems used to drive and feed the transducer is often so complex or difficult as to be prohibitive to the particular use.

The following prior art examples are stand alone inertial type voice coil type actuators. Equally, electromechanical energy can be applied to a substrate via piezoelectric devices that can transfer vibration energy into a substrate inducing sound. Other devices made to vibrate at acoustic frequencies and attached to a substrate which is then made to vibrate at like frequencies will cause the substrate to produce sound and would also benefit from the novel inventions described herein.

U.S. Pat. No. 6,516,071 to Liu and Yu Tsao describes a picture frame loudspeaker. The speaker operates by employing a voice coil within a magnetic field. The voice coil moves within the field in response to electrical current, and vibrates a vibration board which, in turn, produces sound. U.S. Pat. No. 5,473,700 to Fenner, Jr. describes another inertial type actuator capable of producing audio content. As commonly found in this art, a voice coil is positioned within a magnetic field and moves against a substrate to produce sound. The whole is housed in a compliant plastic housing. U.S. Pat. No. 5,434,458 to Stuart et al, discloses a voice coil actuator capable of producing sound when attached to a compliant substrate. In U.S. Pat. No. 7,386,144 Saint-Vincent, et al shows another inertial voice coil type actuator. This actuator is made to attach to a given substrate by way of receiver being connected to the output disc of the actuator. As is clear, there have been and continue to be a variety of manners in which inertial-type acoustic transducers are used and mounted.

These referenced embodiments are intended to at least minimally serve the purposes intended, to produce sound using an inertial type or momentum transducer regardless of the format of the devices used. Still, there are non-trivial problems that dictate that these solutions are incomplete and warrant a novel solution to better the momentum, or inertial type sound generating devices.

One of the novel aspects of most of the above described devices is to have them be hidden from view. This often means installing the device within walls or other structures. However, both the installation of the device and feeding the transducers with desired audio content can be difficult and problematic.

Almost all of the cited patents include some form of structure that holds in place the components of the inertial type acoustic actuators. This structure can be, but is not limited to a frame or a housing. Speaker wires are typically attached to some format of terminals or inputs on the transducers. The wires permit the transducers to be fed with audio content. The wires typically emanate from an audio amplifier which is coupled with some format of an audio source such as a compact disc player, digital storage medium, streaming audio from a computer or network, etc.

The problem arises when the sound generating devices or transducers are to be installed, by way of example, onto a product, or into an architectural edifice. Running wires from the amplifier to the transducer can be prohibitive as the transducer devices are preferably hidden within the structures they are attached to. The audio devices may be attached inside wall cavities, in the ceiling plenum or other typically closed or hard to access areas.

Electrical line voltage wires are typically found within the wall cavity or in the ceiling plenum or products. This can provide power to any subsystem that can drive the transducer such as an audio amplifier. Therefore, making the amplifier local or integrated into the inertial type acoustic actuator or other audio device would avoid or at least greatly reduce the often complicated installation of wires that would otherwise connect such devices. Employing an integrated audio amplifier would save time and expense in the installation process. The integration of the amplifier and preferably its power supply, into device structure or housing would be beneficial, but accomplishing the integration, in turn, raises new issues.

It is beneficial to integrate the audio amplifier and its power supply into the transducer. It is not beneficial to integrate the source for the amplifier into the transducer as the source would then be inaccessible to the user. Source information may be in the format of a digital storage device, distributed audio, or other sound source. It is important that the source be accessible to the user in order to allow selection, change and control of the source information. Connecting the source to the audio amplifier via a remote wireless means would provide many advantages. For example, wireless connection would increase speed and efficiency of installations and reduce cost expenditures related to same. These improvements are the result of using no wires to run from the source to the audio amplifier and from the amplifier to the transducer. Further, the audio amplifier could be co-located with or within the inertial type audio transducer. Employing wireless connection would create a means to facilitate installation of the transducer even deeply embedded within a structure far from the source where direct wiring would be prohibitive and costly.

These remote means of inputting source information may be done via various technologies such as radio frequency transmitters, infrared, laser or other wireless transmitters as well as their counterpart receivers attached or preferably integrated into the amplifier or device housing collocated on the inertial type audio transducer or in the direct vicinity of the transducer.

Example of an audio signal wireless transmission means can be found in U.S. Pat. No. 5,832,024, Schotz, et al., where the inventive means is relative to the technologies derived to send a radio frequency signal from a source coupled with a transmission station and antennae, wirelessly to a receiver antennae and transduction means. The focus of the '024 patent is on the actual wireless audio and control signal transmission means. Such a technology whether in the public domain or licensed would form an example of a candidate wireless transmission means used in the novel inventive means described herein. There are also other plausible wireless transmission means that could be employed.

### SUMMARY OF THE INVENTION

1) It is therefore an object of the present invention to provide a novel system whereby an inertial type audio transducer or an inertial type voice coil actuators (both hereinafter “transducer(s)”) can be installed and create sound without extraneous wires attached.
2) It is further an object of this invention to create an inertial type audio transducer and integrate various subsystems therein to support their use.
3) It is further an object of this invention to integrate an audio amplifier to the inertial type transducer and wireless source signal receiver to the inertial type transducer to permit ease of installation.
4) It is further an object of this invention to integrate to the inertial type audio transducer an amplifier, its electrical power supply if required, and a wireless receiver for source and control information to be fed to the inertial type transducer's audio amplifier.
5) It is an object of this invention to reduce the wiring required to cause the system to provide for simpler installation into difficult situations where installing additional wires is difficult or not possible;
7) It is further an object of this invention to provide an inertial type transducer which requires only an electrical power feed to function while embedded in other structures and which does not need wires for transmission from its audio source.
8) It is further an object of this invention to create a novel means by way of a systems approach, to resolve the problematic aspects of the audio system including installation, supply of source information, and amplification aspects of the above mentioned inertial type actuators;
9) It is further an object of this invention to provide a means to integrate a wireless source and control receiver technology into an inertial type audio transducer in a fashion to optimize is functioning;
10) Another object of this invention is to manage and dissipate heat produced by the transducer, so as to improve efficiency of the transducer, and ensure longevity.

### BRIEF DESCRIPTION OF THE DRAWINGS

In the appended drawings:

FIG. 1 is a top perspective view of an inertial type acoustic transducer according to a non-restrictive illustrative embodiment of the present invention;

FIG. 2 is a schematic cross-sectional view taken along line A-A of FIG. 1 according to a first non-restrictive illustrative embodiment of the present invention;

FIG. 3 is a perspective view of an internal suspension means of the non-restrictive illustrative embodiment of the present invention;

FIG. 4 is a schematic cross-sectional view taken along line A-A of FIG. 1 according to a second non-restrictive illustrative embodiment of the present invention

FIG. 5 is an exploded perspective view of the upper housing components of FIG. 1 according to a non-restrictive illustrative embodiment of the present invention;

FIG. 6 is a perspective view of the transducer and externalized electrical component housing according to an alternate non-restrictive illustrative embodiment of the present invention.

FIG. 7 is a perspective view of the transducer of FIG. 1 and an internalized electrical component housing according to an alternate non-restrictive illustrative embodiment of the present invention.

### DETAILED DESCRIPTION OF THE INVENTION

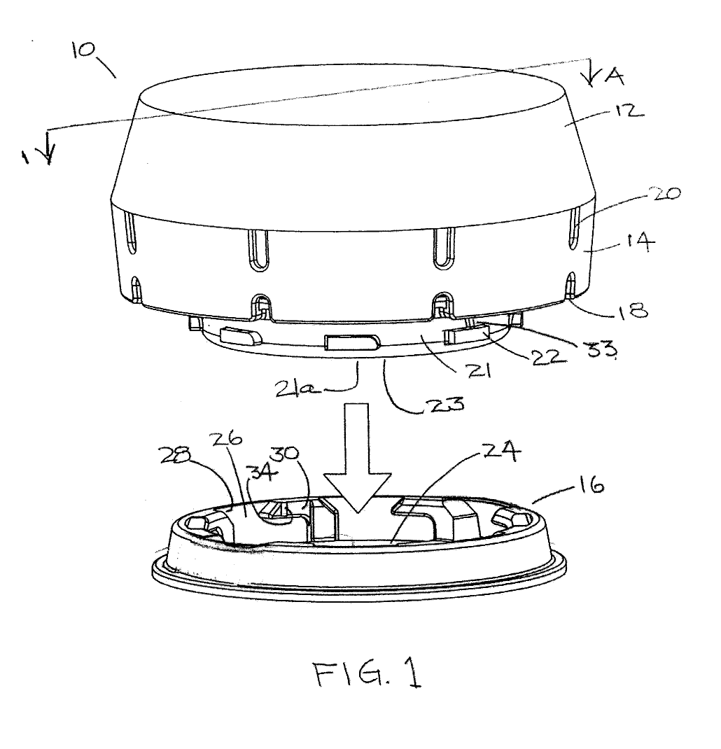

In the non-restrictive illustrative embodiment of the present invention a top perspective view of the present invention is illustrated in FIG. 1 which shows a cross section line AA through the center of the inertial type acoustic transducer 10. The transducer 10 is characterized by a housing, preferably an upper housing 12 and a lower housing 14. A means for mounting the transducer 16 lies beneath the transducer 10 and serves to mount the inertial type acoustic transducer 10 to a soundboard or substrate which functions as a sound emitter when energized by the acoustic transducer 10. Said means for mounting the transducer 16 may be affixed to a soundboard or substrate mechanically, adhesively or by other like means. The transducer upper housing 12 and lower housing 14 are further characterized by means to dissipate heat 18 and 20. In the preferred embodiment, said means to dissipate heat comprise a plurality of convective ventilation openings 18 and 20. Said plurality of openings 18 and 20 may be present at various positions throughout the upper housing 12 and lower housing 14 and not limited to those shown.

On the lower housing 14 are means to associate said transducer 21a with said means for mounting said transducer 16. In the preferred embodiment, said means to associate said transducer with said means for mounting said transducer comprises a cylindrical element 21 comprising at least one, and preferably a plurality of engagement tabs 22 on the lower housing 14. The plurality of engagement tabs 22 serve to retain the transducer 10 to the means for mounting said transducer 16. Specifically, when said plurality of engagement tabs are enganged, a distal surface 23 of the transducer 10 and a bottom surface 24 of the means for mounting said transducer 16 are in contact and removably associated. In the preferred embodiment, a compressive association is created between the distal surface 23 and the bottom surface 24 by inserting each of said plurality of tabs 22 along an inner wall 28 of the mounting apparatus 16 into one of a plurality of openings 26 and counter turning the mounting apparatus 16 and the transducer 10 slightly to move each of the plurality of tabs 22 into contact with one of a plurality of sloped surfaces 30. The pressure of each of the plurality of sloped surfaces 30 on each of the plurality of tabs 22 causes the distal surface 23 and the bottom surface 24 to be compressed against each other.

In an even more preferred embodiment, at least one over center snap ridge 34 along with at least one associated snap ridge 33 found on the cylindrical surface 21 of the lower housing 14, prevents the transducer 10 and the plurality of engagement tabs 22 from autonomously untwisting from its engagement from the wedge sloped surfaces 30. It should be noted that the distil surface 23 may be slightly convex at its center to ensure accurate pressure transfer between the transducer 10 and the means for mounting said transducer 16.

It should be noted that there are alternative ways to secure the means for mounting said transducer 16 to a substrate including adhesives. Further, said means for securing said transducer 21a to said means for mounting said transducer 16 may be of other alternatives. One such alternative comprises screw threaded means, whereby the distal surface 23 of the transducer 10 may comprise a threaded element integrated thereto, where the threaded element would then turn into a mating threaded receiver portion generally in the center of the mounting apparatus 16.

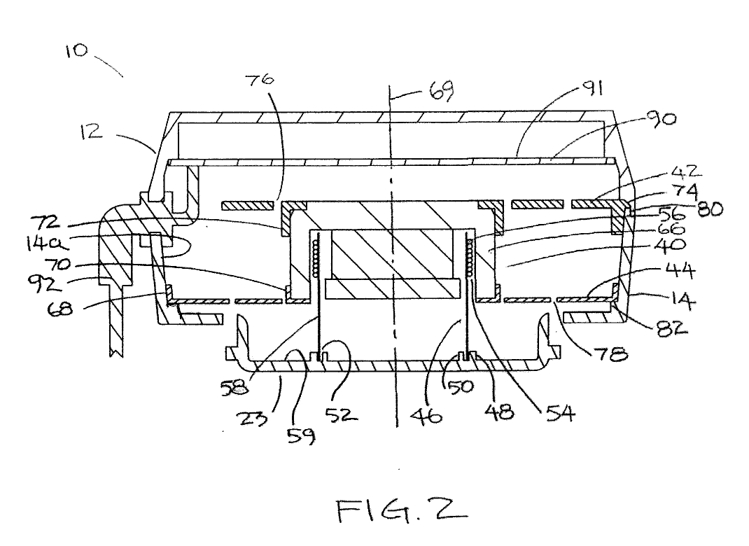

Referring to FIG. 2, the transducer is characterized by lower housing 14 and upper housing 12. A magnetic circuit motor 40 is housed within the transducer 10. The magnetic motor 40 of the transducer 10 is for illustrative purposes only. The magnetic motor 40 may vary greatly and could be easily changed by someone skilled in the art. The motor 40 may be made of, but not limited to various materials including various magnetic materials such as but not limited to neodymium, ferrite, cobalt and magnetostrictive materials including Terfenol or other like materials. The magnetic motor 40 drives a voice coil 46 which is located at least partially within a magnetic gap 54. A first end 59 of a voice coil former 58 is concentrically located in a gap 52 located between a first concentric annular ring 48 and a second concentric annular ring 50. Preferably, a heat conductive adhesive would fill the gap 52 holding the first end of the voice coil former 59 fixed in place and in contact with the lower surface 23 of the transducer 10.

An electrically conductive winding 56 are wound around the voice coil former 58. The magnetic motor 40 comprises a cap 62, at least one magnet 64 and a cup 66. The at least one magnet 64 could be made of a wide variety of magnetic materials which can be optimized by someone skilled in the art. The cap and the cup should be of materials that are magnetizable.

The magnet motor 40 is suspended within the transducer 10 concentrically about the center line 69 by way of a first suspension element 42 and a second suspension element 44. Preferably, the suspensions elements 42 and 44 are spaced apart along the motor 40 and the center line 69 and hold the magnetic motor 40 in place by way of association with at least one concentric ring 70 which can be affixed to the magnetic motor 40 mechanically, adhesively or compressively. A second concentric ring 72 can also be affixed to the magnetic motor 40 and associated with suspension elements 42 and 44. Most preferably, the suspension ring 42 comprises an outer portion 74 affixed to the upper housing 12 and lower housing 14 at their joint line 80 or by other like means including mechanical and adhesive assembly. The lower suspension element 44 abuts a stepped abutment 82 and a concentric ring 68 may be adhesively bonded or otherwise affixed to an inner wall 14a of housing 14. These assembly means can vary greatly by anyone skilled in the art and are for illustrative purposes only.

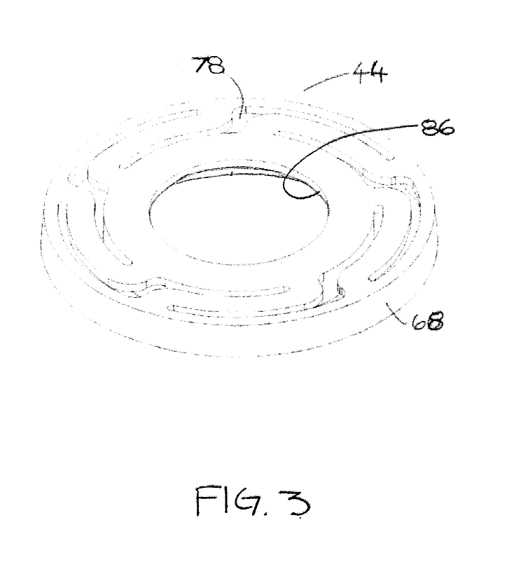

Referring to FIG. 2 and FIG. 3, the suspension elements 42 and 44 are exhibited and show a plurality of openings 78 which permit axial translation of the center hole 86 surrounded by concentric ring 68 holding the magnetic motor 40 and a center hole 86. The inherent geometries of the openings 78 are non-compliant laterally and impede the center hole 86 from translating normal to the center axis 69. This ensures the motor structure 40 does not cock about the center axis 69 when affixed to the suspension elements 42 and 44. By way of this, the voice coil former 46 and coil windings 56 are held in axial alignment within the magnetic air gap 54.

When being operated the magnetic motor 40 will produce heat as a byproduct of its operation. As the preferred embodiments described herein may be housed in closed wall cavities or other environments where free flow of air is not readily available, and by way of the fact that the displacement of the voice coil 46 is minimal due to the design of this inertial type acoustic actuator 10, thermal management means is important. Heat could have a negative effect on the magnet 64 and the overall efficiency of the magnetic motor 40.

Referring to FIG. 1, to help manage heat production of the magnetic motor 40, means for dissipating heat comprise the plurality of openings 18 and 20 as well as the plurality of openings 76 on the suspension element 42 and 78 on suspension element 44. These openings will allow convective air currents to be established as the magnetic motor 40 executes work and is heated. It should be noted that the openings 18, 20, 76, and 78 may be configured differently and optimized by someone skilled in the art.

Additionally, conduction will very effectively assist in drawing heat away form the magnetic motor structure 40 and the voice coil former 46 and conductive windings 56. To do so, materials which are thermally conductive may be chosen for all components of the transducer 10, including but not limited to the magnetic motor 40, suspension elements 42 and 44, coil windings 56, voice coil former 58, housings parts 12 and 14. The glues utilized in the assembly of said components if used can be thermally conductive in nature. What is meant by thermally conductive is a material which has a higher propensity for thermal conductivity compared to alternate materials which would simply suffice for mechanical and functional purposes. By way of example, the housing 14 could be fabricated in a conductive metal such as aluminum as opposed to standard thermoplastics. Even if thermoplastics are chosen, the grade of thermoplastic could be chosen for its engineered thermal conductivity as compared to more standard commodity or engineering grades thermoplastics which are not typically engineered for thermal conductivity. Another example would be the use of a brass or other thermally conductive material voice coil former 46 as opposed to the use of a less thermally conductive material such as but not limited to Kapton. In general, the coil windings 56 and voice coil former 46 would draw heat from the magnet motor 40. Heat conductive adhesives would then transfer such heat to the lower portion of the transducer housing 14. Heat from the housing would then be conductively transferred to the mounting apparatus which could be made of a thermally conductive thermoplastic or metal by way of example. If the substrate is thermally conductive it could absorb and dissipate heat drawn from the mounting apparatus. The upper housing 12 would be able to absorb heat as well transferred by way of the thermal bridge created by its connection to the lower housing 14, and both housing parts could absorb heat from the ambient air found within the transducer 10 and radiate this heat through the thermally conductive materials used in the housing parts 12 and 14. The use of the mounting apparatus 16 would equally form part of the thermal management system as it would draw heat away by way of the intimate contact it makes with the lower portion of the transducer housing 14. Ferro fluid could equally be used in the air gap 54 for heat transfer from the conductive coil 56 to the magnetic motor structure 40 which body could aid in absorbing and radiating heat produced through work by the transducer 10.

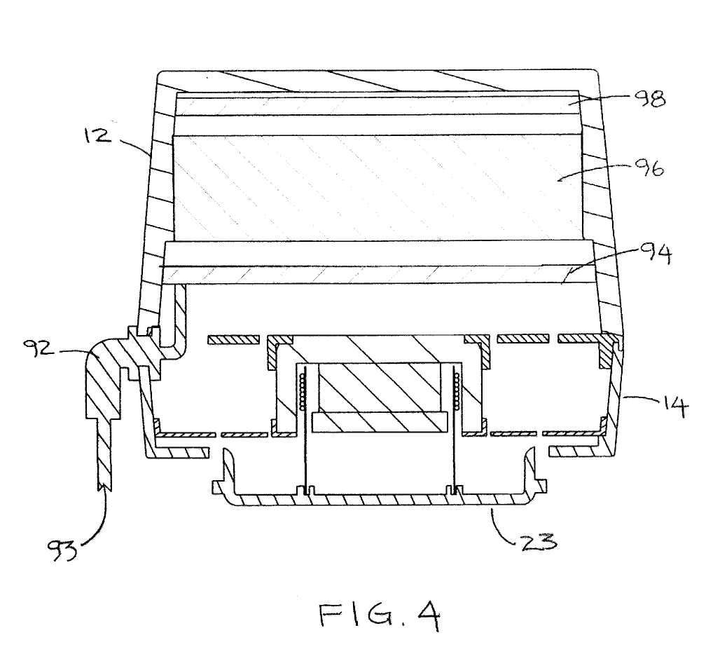

Referring to FIG. 2 and FIG. 4, the upper housing 12 is affixed to the lower housing 14 by adhesively bonding, ultrasonic welding or other such means. The upper housing 12 holds critical components. Between upper housing 12 and lower housing 14 strain relief and a power cord 92 carrying electrical current and preferably line voltage electrical current are affixed via preferably mechanical means such as being sandwiched between the housing parts 12 and 14 as shown. A printed circuit board 90 may constitute an electrical circuit for an audio amplifier 94 forming part of said printed circuit board 90 and a wireless radio frequency receiver 98 also forming part of the said printed circuit board 90. For illustrative purposes the audio amplifier 94 forming part of the said printed circuit board 90 and radio frequency receiver 98 also forming part of the said printed circuit board 90 may be populated on both or either sides of the printed circuit board 90 with the radio frequency receiver 98 forming part of the said printed circuit board 90 preferably on the upper surface 91 so as to be best exposed for reception of signals. Alternatively, one or both of the amplifier 94 or the receiver 98 may be comprised of a module separate from the circuit board 90. It is important to note that if no antennae is needed, or an internal antenna can be used, the materials forming upper housing 12 must be transparent to the radio frequency signals. This can be accomplished via openings or the selection of the correct materials. Many thermoplastic materials can be used. The radio frequency receiver 98 forming part of the said printing circuit board 90 receives a signal from a base station located within the reception range of the receiver portion forming part of the said printing circuit board 90.

The signal sent by a transmitter (not shown) and received by the receiver 98 forming part of the said printed circuit board 90 or separate therefrom, preferably contains an audio content signal that the user wishes to be amplified at the transducer 10 and ultimately reproduced by the transducer 10. The transmitter (not shown) is located convenient to the user for ease in changing and controlling the audio content signal source information. The transmitter (not shown) would preferably also comprise control means for the amplifier 94 forming part of the said printed circuit board 90 or separate therefrom and contained in or about the transducer 10 and would employ the same radio frequency signal. Volume and tone controls are examples of some of the varied control parameters of the amplifier 94 that would be controlled at the transmitter.

The content of the audio content signal sent by a transmitter (not shown) is then sent to the audio amplifier forming part of the said printed circuit board 90 where the audio content signal is amplified and transduced to an electrical signal sent to the voice coil 46 and its coil windings 56 specifically. The electrical signal is then transduced into work conducted by the magnetic motor 40 producing sound by the transducer 10 as it is affixed to the mounting apparatus 16 which is in turn affixed to a soundboard. The end result is sound production.

It should be noted that the non-restrictive illustrative embodiment of the present invention has referred to the wireless signal to be sent via radio frequency, but for the purposes of this invention it should be stated that this is not the only means of signal transmission, which may be sent via infra red signal, laser light signals, or other means of wireless signal processing, transmission and reception.

Referring back to FIG. 1, lower housing bottom surface 23 may be used to attach the housing to the desired substrate or surface which shall act as the soundboard for the transducer. This may be done adhesively, or by way of a number of mechanical means such as a helicoidal wedge attachment means or other means obvious to someone skilled in the art. The mounting apparatus 16 is an example of such a means to affix the transducer 10.

Referring to FIG. 4, upper housing 12 may contain additional subsystem components to render the transducer 10 to be an autonomous unit. As the audio amplifier 94 optionally forming part of said printed circuit board 90 and radio frequency receiver 98 optionally forming part of the said printed circuit board 90 will require electrical power to function, and the environments into which the transducer 10 will be installed into often do contain power lines, any such line 93 could be used to feed the electrical input requirements of the transducer 10 and its sub systems 94, 96 and 98.

In FIG. 4, transducer 10 is characterized by amplifier board 94, electrical power supply 96 and wireless radio frequency receiver 98. It should be noted that the power supply 96 may be formatted to be assembled as shown within the upper housing 12. The internal subsystem components 94, 96, and 98 may be secured into the housing standard means such as but not limited to snap fits and mechanical fasteners. The power supply 96 would ideally convert line voltage power to the voltages required by the audio amplifier 94 and the wireless radio frequency receiver 98. Once the wireless signal is received by the receiver 98, the signal is sent to the audio amplifier 94 which in turn amplifies the signal and sends it via wired means to the voice coil 56.

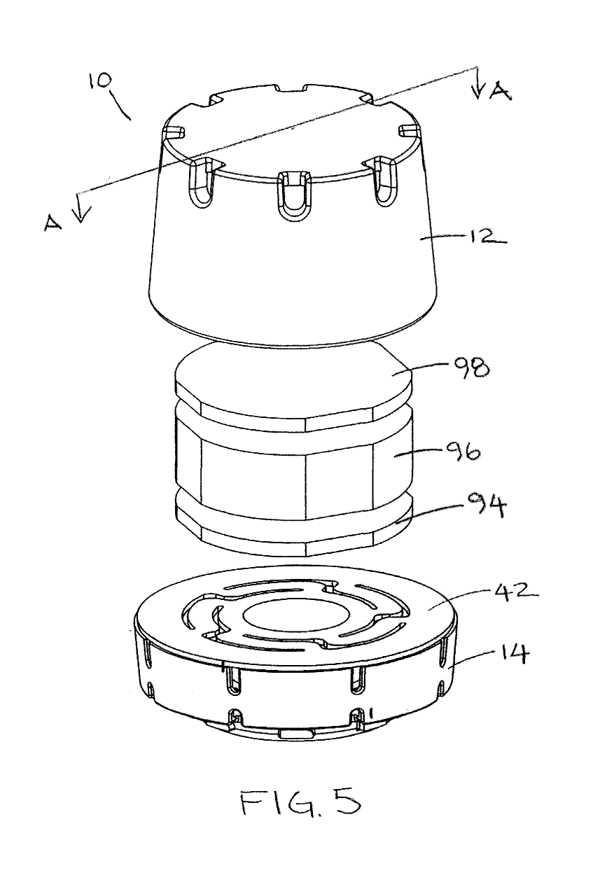

FIG. 5 shows an exploded view of the transducer 10 exhibiting general volume shapes of the audio amplifier printed circuit board 94, the power supply 96 and the wireless signal receiver 98.

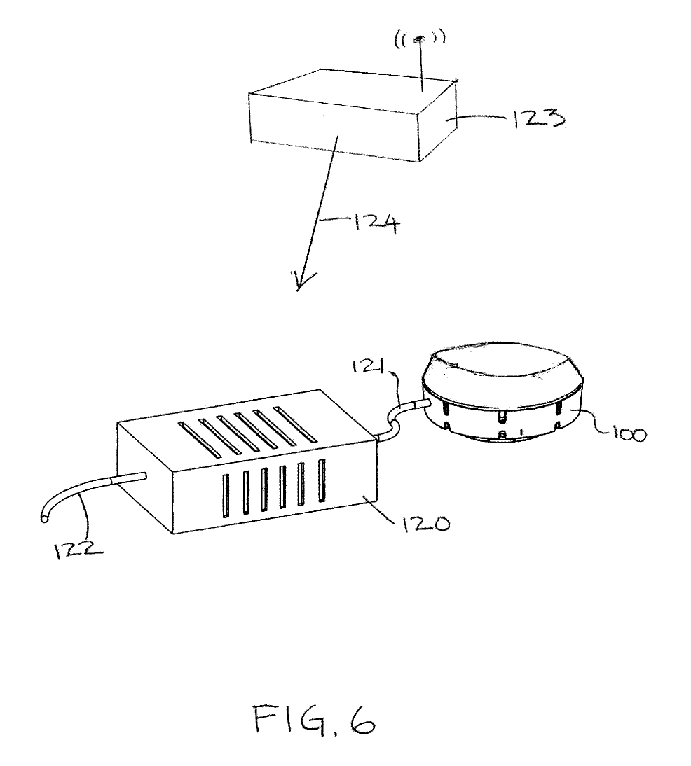

Taking this alternate non-specific preferred embodiment a step further and referring to FIG. 6, a stand alone transducer 100 may be supported by an adjacent housing 120 containing any or all subsytem components 94, 96 and 98 found in upper housing 12 of FIG. 4 and possibly other electrical utilities that would bring enhancements to the system. The wire 121 sends signal to the transducer 100, and the wire 122 is the electrical power feed found commonly in the ceiling plenum, wall cavity or other installation space within a building or product. The wire 121 may be of varying length, but with the intent to render the installation of the transducer 100 within the same general area of the electrical component housing 120 for simplification of the installation. The housing 120 could be designed in a number of ways obvious to someone skilled in the art but would include thermal considerations and other considerations to render specific conformity with national standard governing bodies and underwriters. As with all non-specific preferred embodiments illustrated herein, the audio source, source information transmitter and amplifier control element 123 is located at a distance form the receiver found in housing 120 or alternatively housing 12 as shown in FIG. 2 and FIG. 4. Signal and control transmission is characterized schematically by arrow 124 which illustrates a wireless means to send such signals to the various components of the various components of the audio system.

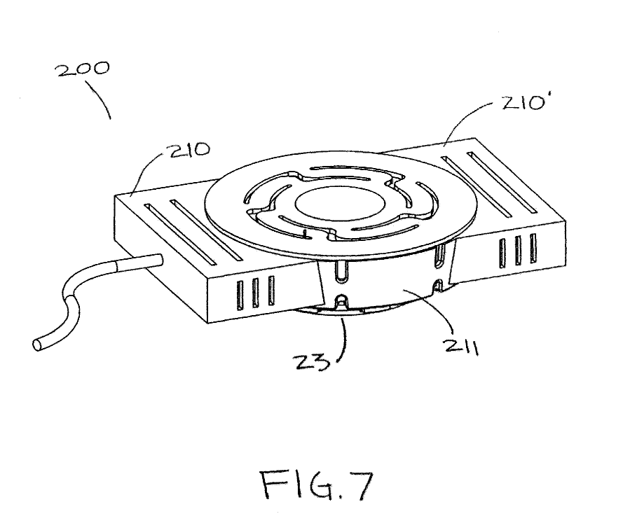

In yet another alternate non-specific preferred embodiment a step further and referring to FIG. 7, it may be necessary to reduce the overall height of the transducer and incorporated subsystems. The housing elements 210 and 210′ forming part of an inertial type audio actuator 200 can be formatted to have the internal components organized such that the incorporated components are placed below the overall height of the main transducer component 211. It would be advantageous to further format the housing to optimize the center of gravity of the internal components, such that the mass would be best distributed around the contact surface 23. If the housing is to be placed with its central axis of the voice coil or reciprocating movement oriented vertically.

1. An inertial type acoustic transducer associated with a substrate comprising a wireless receiving means for receiving source signals.

2. The inertial type acoustic transducer of claim 1 further comprising a housing, means for amplifying sound signals by transducing each said signal to an electric signal, and a power supply, said wireless receiving means and said means for amplifying sound signals positioned inside said housing.

3. The inertial type acoustic transducer of claim 1 further comprising means for amplifying sound signals by transducing said signals to an electric signal and an electrical power supply.

4. The inertial type acoustic transducer of claim 2 further comprising means for mounting the transducer to said substrate, and means for dissipating heat comprising a plurality of convective ventilation openings.

5. The inertial type acoustic transducer of claim 2 further comprising a magnetic motor, a voice coil upon a voice coil former located at least partially within a magnetic gap, said voice coil receiving transduced electric signals from said means for amplifying sound signals causing said voice coil to move within said gap, and said voice coil former in communication with a lower surface of the transducer for transducing movement of said voice coil to said substrate.

6. The inertial type acoustic transducer of claim 5 wherein said magnetic motor is suspended within said lower housing by at least one suspension element.

7. A system for reducing wiring needs and simplifying installation and operation of at least one inertial type acoustic transducer positioned internal to a structure, said system comprising:
a) at least one inertial type acoustic transducer;
b) a substrate associate with each of said at least one inertial type acoustic transducers for radiating sound;
c) for each of said at least one inertial type acoustic transducer, a power supply, a wireless signal receiving means for receiving a plurality of sound content signals and a plurality of control signals, and means for amplifying said sound signals according to said control signals;
d) at least one of said wireless receiving means, said amplifying means or said power supply located internal to each of said at least one inertial type acoustic transducer; and
e) a transmitter remote from said at least one inertial type acoustic transducer for transmitting sound content signals and control signals to each said means for amplifying sound signals.

8. An inertial type acoustic transducer comprising a housing and a wireless receiving means for receiving source signals, said wireless receiving means positioned internal to said housing.

9. The inertial type acoustic transducer of claim 8 further comprising a power supply and means for amplifying sound signals positioned internal to said housing.

10. The inertial type acoustic transducer of claim 9 wherein said wireless receiving means also receives control signals.

11. The inertial type acoustic transducer of claim 9 further comprising a circuit board positioned internally of said housing.

12. An inertial type acoustic transducer comprising a housing substantially enclosing a magnetic motor, a wireless receiving means for receiving source signals, means for amplifying sound signals by transducing each said signal to an electric signal, and an adjacent housing substantially enclosing any combination of said wireless receiving means, means for amplifying sound signals, and a power supply said adjacent housing proximal to said housing substantially enclosing said magnetic motor.

13. The inertial type acoustic transducer of claim 2 further comprising means for mounting the transducer to said substrate, and means for dissipating heat comprising a plurality of heat conduction and radiation means.

14. A system for reducing wiring needs and simplifying installation and operation of at least one inertial type acoustic transducer positioned on a structure, said system comprising:
f) at least one inertial type acoustic transducer;
g) a substrate associate with each of said at least one inertial type acoustic transducers for radiating sound;
h) for each of said at least one inertial type acoustic transducer, a power supply, a wireless signal receiving means for receiving a plurality of sound content signals and a plurality of control signals, and means for amplifying said sound signals according to said control signals;
i) at least one of said wireless receiving means, said means for amplifying sound signals or said power supply located internal to each of said at least one inertial type acoustic transducer; and
j) a transmitter remote from said at least one inertial type acoustic transducer for transmitting sound content signals and control signals to each said means for amplifying sound signals.

15. An inertial type acoustic transducer associated with a substrate comprising a circuit board, said circuit board further comprising a wireless receiving means for receiving source signals and means for amplifying sound signals.
